(19) United States
(12) Patent Application Publication
(10) Pub. No.: US 2007/0048419 A1
(43) Pub. Date: Mar. 1, 2007

(54) METHOD FOR PRODUCING FROZEN FOOD

(76) Inventors: Fumio Noda, Nanao-shi (JP); Minoru Noda, Moriya-shi (JP); Shuji Yamamoto, Nanao-shi (JP); Iaamu Yoshino, Nanao-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/457,165

(22) Filed: Jul. 13, 2006

(30) Foreign Application Priority Data
Aug. 24, 2005 (JP) 2005-243343

(51) Int. Cl. A21D 4/00

(52) U.S. Cl. 426/321

(57) ABSTRACT

The purpose of the present invention is to provide a method for producing a frozen food having a texture, which is similar to that in a state before freezing, even after defrosting. The means for solution of the present invention is a method for producing a frozen food comprising the steps of: immersing at least one food material selected from the group consisting of vegetables, fruits, seafoods and eggs, in an aqueous solution containing salt, saccharide and calcium salts; and freezing the food material immersed in the aqueous solution by being passed through a temperature range of 0 to −50° C. within 15 minutes to reach a temperature range of −20° C. or less. The aqueous solution contains 1 to 5 wt % of salt, 2 to 10 wt % of saccharide and 0.1 to 0.5 wt % of calcium salts.

### BACKGROUND OF THE INVENTION

1. Field of the Invention

The present invention relates to a method for producing frozen foods such as frozen vegetables, frozen fruits, frozen seafood and the like, wherein vegetables and fruits immediately after harvest, or seafoods and eggs immediately after a catch are immersed in an aqueous solution containing salt, saccharide and calcium salts, and after that, subjected to a rapid freezing treatment.

2. Description of the Related Art

Generally, vegetables and seafoods have an appropriate underlying harvest/catch time, which is so-called “the season”. In the season, vegetables and seafoods have a superior taste, and the harvest/catch amounts thereof are increased. However, the supreme tastes of these vegetables and seafoods in the season can be enjoyed only for a short period of time. Further, when these vegetables and seafoods are harvested or caught more than expected, a price collapse occurs, and for this reason, these vegetables and seafoods are often discarded.

For a conventional method for freezing and preserving foods, for example, Japanese Laid-Open Publication No. 2004-105083 discloses a process for producing a frozen apple and a method for producing the same, wherein: the pulp of an apple is deaerated under reduced pressure; the pulp is then immersed in an aqueous solution containing calcium and ascorbic acid; the immersed pulp is subsequently subjected to a blanching treatment (heat treatment); saccharides are further added thereto after cooling; and the product is frozen and preserved.

However, the purpose of the invention described in the above-described patent document is to provide a frozen apple processed to retain a crisp texture, which is specific for apples, but not to retain tastes of foods in “the season” Further, the patent document does not disclose immersing a food in a solution comprising specific amounts of salt, saccharide and calcium salts and thereafter freezing the immersed food rapidly.

Japanese Laid-Open Publication No. 2002-176908 discloses a method for producing a processed fish, wherein a sectioned raw fish, in which its internal organs are removed, is immersed in a salt solution containing potassium chloride and sodium ascorbate, and subsequently the immersed raw fish is dried.

However, the purpose of the invention described in the above-described patent document is to produce a processed fish presenting a good color, but not to retain tastes of foods from the season. Further, the patent document does not disclose immersing a food in a solution comprising specific amounts of salt, saccharide and calcium salts and thereafter freezing the immersed food rapidly.

Japanese Laid-Open Publication No. 2003-339338 discloses a method for processing a fruit and a vegetable, wherein the fruit or the vegetable is immersed in an ionized alkaline water, and subsequently the material is removed from the ionized alkaline water and frozen, and subjected to a defrosting/drying treatment after a predetermined amount of time.

However, the purpose of the invention described in the above-described patent document is to remove an acerbity component, but not to retain tastes of foods in the season. Further, the patent document does not disclose immersing a food in a solution comprising specific amounts of salt, saccharide and calcium salts and thereafter freezing the immersed food rapidly.

### SUMMARY OF THE INVENTION

The present invention was aimed at solving the above-described problem. The purpose of the present invention is to provide a method for producing a frozen food having a texture, which is similar to that in a state before freezing, even after defrosting.

The present inventors diligently researched a novel method for preserving food materials, wherein tastes of foods in the season can be enjoyed any time and food materials are not discarded. It was subsequently found, that the above-described purpose can be accomplished by immersing a food material in a solution comprising specific amounts of salt, saccharide and calcium salts and thereafter freezing the immersed food rapidly. The present invention was thus proposed.

The present invention describes a method for producing a frozen food comprising the steps of: immersing at least one food material selected from the group consisting of vegetables, fruits, seafoods and eggs, in an aqueous solution containing salt, saccharide and calcium salts; and freezing the food material immersed in the aqueous solution by being passed through a temperature range of 0 to −5° C. within 15 minutes to reach a temperature range of −20° C. or less, and thereby the above-described purpose can be accomplished.

In one embodiment of the present invention, the aqueous solution contains 1 to 5 wt % of salt, 2 to 10 wt % of saccharide and 0.1 to 0.5 wt % of calcium salts.

In one embodiment of the present invention, the step of freezing comprises the step of freezing the food material immersed in the aqueous solution by being passed through a temperature range of 0 to −5° C. within 12 minutes to reach a temperature range of −25° C. or less.

In one embodiment of the present invention, the aqueous solution contains 2 to4 wt % of salt, 3 to 8 wt % of saccharide and 0.1 to 0.3 wt % of calcium salts.

In one embodiment of the present invention, the saccharide is at least one selected from the group consisting of trehalose, sugar, oligosaccharide, sugar alcohol, starch syrup and reduced starch syrup.

In one embodiment of the present invention, the calcium salts are at least one selected from the group consisting of calcium citrate, calcium lactate, calcium gluconate, calcium chloride, calcium carbonate and calcium phosphate.

By immersing a food material in an aqueous solution containing salt, saccharide and calcium salts and thereafter freezing the food material to pass through a temperature range of 0 to −5° C. within 15 minutes, and reach a temperature range of −20° C. or less, enzymes contained in the food materials are inactivated to retain freshness (a texture at the time of a harvest or a catch). In addition, growth of ice crystals, which is formed with water contained in the food material, is inhibited, thereby preventing tissue breakdown, and subsequent flowing out of the good taste (umami) component at the time of defrosting is prevented. Thus, the state of the food material before freezing can be retained.

These and other advantages of the present invention will become apparent to those skilled in the art upon reading and understanding the following detailed description.

### DESCRIPTION OF THE PREFERRED EMBODIMENTS

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

Hereinafter, embodiments of the present invention will be explained in detail.

At least one food material selected from the group consisting of vegetables, fruits, seafoods and eggs are used in the present invention.

Target vegetables are all fresh and unprocessed, including root vegetables and leafy vegetables. Both peeled fruits and unpeeled fruits can be used in the present invention, but peeled ones are preferred.

Examples of vegetables include, but are not limited to, Chinese radish, turnip, carrot, burdock, onion, cucumber, bean sprouts, Japanese butterbur, cabbage and Chinese cabbage. Examples of fruits include, but are not limited to, pineapple, apple, pear, tangerine, grape, peach and banana.

All fresh and unprocessed seafoods and Mollusca can be used as target seafoods. Examples of seafoods, include sea bream, saury, carangid, scombrid, walleye pollock, cod, Atka mackerel, white croaker, lizard fish, sardine, cuttle fish, octopus, shrimp and scallop. Seafoods from which their internal organs are removed, are preferably used.

All eggs including hard roe and eggs of fowl can be used as a target egg.

Examples of salt, saccharide and calcium salts to be used for an immersion solution are described below.

Examples of salts include rock salt, solar salt and purified salt. An essential function of salt is to inactivate enzymes contained in food materials such as vegetables, fruits, seafoods and eggs.

As the above-described saccharide, trehalose, sugar, oligosaccharide, sugar alcohol, starch syrup and reduced starch syrup are preferably used. Further, these materials can be used in combination.

As the above-described calcium salts, both inorganic salts and organic salts can be used.

Examples of the calcium salts include calcium citrate, calcium lactate, calcium gluconate, calcium chloride, calcium carbonate and calcium phosphate. These calcium salts can be used in combination.

Typically, 1-5 wt % of salt, 2-10 wt % of saccharide, and 0.1-0.5 wt % of calcium salts are dispersed (or dissolved) in water to prepare an aqueous solution. More preferably, 2-4 wt % of salt, 3-8 wt % of saccharide, and 0.1-0.3 wt % of calcium salts are contained in the aqueous solution. When the content of salt, saccharide or calcium salts is lower than the above-described range, freshness of a frozen food after defrosting may be low. When the content of salt, saccharide or calcium salts is higher than the above-described range, texture of a frozen food after defrosting tends to be deteriorated.

The above-described food material is immersed in the aqueous solution containing salt, saccharide and calcium salts. The temperature of the aqueous solution and immersing time varies depending on a kind of the food material. Usually, the temperature of the aqueous solution is 0-25° C., and preferably 5-10° C., and the immersing time is 2-20 hours, and preferably 3-15 hours.

After that, the food material immersed in the aqueous solution is frozen by being passed through a temperature range of 0 to −5° C. within 15 minutes to reach a temperature range of −20° C. or less. Any freezing treatment, in which the temperature range of 0 to −5° C. is passed through within 15 minutes and the temperature range of −20° C. or less is reached, can be used in the present invention. Preferably, freezing is carried out at a temperature of −25° C. or less. Time for passing through the temperature range of 0 to −5° C. is preferably shorter, and in particular, a 12 minutes or shorter is preferred.

As a freezing means, a high-voltage electric-field alcohol freezing machine, a freezing machine utilizing magnetic field energy, freezing with liquid nitrogen, freezing with dry ice and the like are suitably used.

Thus, a frozen food, which retains good taste of the food material right after a harvest or a catch even after defrosting, can be obtained.

### EXAMPLES

Hereinafter, the present invention will be specifically described by way of illustrative examples.

### Example 1

The relationship between an immersion solution and the quality of a frozen food was examined.

A sliced Chinese radish (diameter: 60 mm, thickness: 30 mm), an apple (peeled and divided into quarters), and a sea bream (length: 20 cm, weight: 200 g) were used as target foods for the test. Each of them was immersed in each of immersion solutions shown in Tables 1-6 at 20°C. for 3 hours, and thereafter rapidly frozen using liquid nitrogen.

Rapid freezing was carried out in the following conditions.

The duration of freezing in the range from 0 to −5° C. was 8 to 10 minutes, and the temperature of the frozen food was −38° C.

The frozen food was preserved at −38° C. for one month, and then defrosted. The sliced Chinese radish was put into soup (oden dashi-jiru) and subjected to heat treatment at90° C. for 20minutes. The apple was left after defrosting. The sea bream was put into soup (oden dashi-jiru) and subjected to heat treatment at 90° C. for 20 minutes.

Each obtained food was subjected to the sensory test. The results are shown in Tables 1-6.

The sensory test was carried out by a panel consisting of 10 persons The evaluation was expressed as Excellent, Good, Acceptable or Unacceptable. The results were derived from the most-received evaluation.

TABLE 1

| Immersion Solution | | | | | |
|---|---|---|---|---|---|
| Composition (wt %) | | | Target Food of the Test | | |
| | | Calcium | Chinese | | |
| Salt | Trehalose | lactate | radish | Apple | Sea bream |
| 0 | 0 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 1 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 2 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 6 | 0.05 | Unacceptable | Unacceptable | Acceptable |
| | | 0.1 | Unacceptable | Unacceptable | Acceptable |
| | | 0.3 | Unacceptable | Unacceptable | Acceptable |
| | | 0.5 | Unacceptable | Unacceptable | Acceptable |
| | | 0.7 | Unacceptable | Unacceptable | Acceptable |
| | 10 | 0.05 | Unacceptable | Unacceptable | Acceptable |
| | | 0.1 | Unacceptable | Unacceptable | Acceptable |
| | | 0.3 | Unacceptable | Unacceptable | Acceptable |
| | | 0.5 | Unacceptable | Unacceptable | Acceptable |
| | | 0.7 | Unacceptable | Unacceptable | Acceptable |
| | 12 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |

TABLE 2

| Immersion Solution | | | | | |
|---|---|---|---|---|---|
| Composition (wt %) | | | Target Food of the Test | | |
| | | Calcium | Chinese | | |
| Salt | Trehalose | lactate | radish | Apple | Sea bream |
| 0.5 | 0 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 1 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 2 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 6 | 0.05 | Unacceptable | Unacceptable | Acceptable |
| | | 0.1 | Unacceptable | Unacceptable | Acceptable |
| | | 0.3 | Unacceptable | Unacceptable | Acceptable |
| | | 0.5 | Unacceptable | Unacceptable | Acceptable |
| | | 0.7 | Unacceptable | Unacceptable | Acceptable |
| | 10 | 0.05 | Unacceptable | Unacceptable | Acceptable |
| | | 0.1 | Unacceptable | Unacceptable | Acceptable |
| | | 0.3 | Unacceptable | Unacceptable | Acceptable |
| | | 0.5 | Unacceptable | Unacceptable | Acceptable |
| | | 0.7 | Unacceptable | Unacceptable | Acceptable |
| | 12 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |

TABLE 3

| Immersion Solution | | | | | |
|---|---|---|---|---|---|
| Composition (wt %) | | | Target Food of the Test | | |
| | | Calcium | Chinese | | |
| Salt | Trehalose | lactate | radish | Apple | Sea bream |
| 1.0 | 0 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 1 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Acceptable | Acceptable |
| | | 0.7 | Unacceptable | Unacceptable | Unacceptable |
| | 2 | 0.05 | Unacceptable | Unacceptable | Unacceptable |
| | | 0.1 | Good | Good | Good |
| | | 0.3 | Good | Good | Good |
| | | 0.5 | Acceptable | Acceptable | Acceptable |
| | | 0.7 | Unacceptable | Unacceptable | Unacceptable |
| | 6 | 0.05 | Unacceptable | Unacceptable | Unacceptable |
| | | 0.1 | Good | Acceptable | Acceptable |
| | | 0.3 | Good | Good | Good |
| | | 0.5 | Acceptable | Acceptable | Acceptable |
| | | 0.7 | Unacceptable | Unacceptable | Unacceptable |
| | 10 | 0.05 | Unacceptable | Unacceptable | Unacceptable |
| | | 0.1 | Good | Good | Good |
| | | 0.3 | Good | Good | Good |
| | | 0.5 | Acceptable | Acceptable | Acceptable |
| | | 0.7 | Unacceptable | Unacceptable | Unacceptable |
| | 12 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |

TABLE 4

| Immersion Solution | | | | | |
|---|---|---|---|---|---|
| Composition (wt %) | | | Target Food of the Test | | |
| | | Calcium | Chinese | | |
| Salt | Trehalose | lactate | radish | Apple | Sea bream |
| 3.0 | 0 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 1 | 0.05 | Unacceptable | Unacceptable | Unacceptable |
| | | 0.1 | Unacceptable | Unacceptable | Unacceptable |
| | | 0.3 | Acceptable | Acceptable | Acceptable |
| | | 0.5 | Unacceptable | Acceptable | Acceptable |
| | | 0.7 | Unacceptable | Unacceptable | Unacceptable |
| | 2 | 0.05 | Unacceptable | Unacceptable | Unacceptable |
| | | 0.1 | Good | Good | Good |
| | | 0.3 | Excellent | Excellent | Excellent |
| | | 0.5 | Good | Good | Good |
| | | 0.7 | Unacceptable | Unacceptable | Unacceptable |
| | 6 | 0.05 | Unacceptable | Unacceptable | Unacceptable |
| | | 0.1 | Excellent | Excellent | Excellent |
| | | 0.3 | Excellent | Excellent | Excellent |
| | | 0.5 | Excellent | Excellent | Excellent |
| | | 0.7 | Unacceptable | Unacceptable | Unacceptable |
| | 10 | 0.05 | Unacceptable | Unacceptable | Unacceptable |
| | | 0.1 | Excellent | Excellent | Excellent |
| | | 0.3 | Excellent | Excellent | Excellent |
| | | 0.5 | Good | Good | Good |
| | | 0.7 | Unacceptable | Unacceptable | Unacceptable |
| | 12 | 0.05 | Unacceptable | Unacceptable | Unacceptable |
| | | 0.1 | Acceptable | Acceptable | Acceptable |
| | | 0.3 | Acceptable | Acceptable | Acceptable |
| | | 0.5 | Unacceptable | Unacceptable | Unacceptable |
| | | 0.7 | Unacceptable | Unacceptable | Unacceptable |

TABLE 5

| Immersion Solution | | | | | |
|---|---|---|---|---|---|
| Composition (wt %) | | | Target Food of the Test | | |
| | | Calcium | Chinese | | |
| Salt | Trehalose | lactate | radish | Apple | Sea bream |
| 5.0 | 0 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 1 | 0.05 | Unacceptable | Unacceptable | Unacceptable |
| | | 0.1 | Unacceptable | Unacceptable | Unacceptable |
| | | 0.3 | Acceptable | Acceptable | Acceptable |
| | | 0.5 | Unacceptable | Acceptable | Acceptable |
| | | 0.7 | Unacceptable | Unacceptable | Unacceptable |
| | 2 | 0.05 | Unacceptable | Unacceptable | Unacceptable |
| | | 0.1 | Good | Excellent | Good |
| | | 0.3 | Excellent | Excellent | Good |
| | | 0.5 | Good | Good | Good |
| | | 0.7 | Unacceptable | Unacceptable | Unacceptable |
| | 6 | 0.05 | Unacceptable | Unacceptable | Unacceptable |
| | | 0.1 | Excellent | Excellent | Excellent |
| | | 0.3 | Excellent | Excellent | Excellent |
| | | 0.5 | Good | Good | Good |
| | | 0.7 | Unacceptable | Unacceptable | Unacceptable |
| | 10 | 0.05 | Unacceptable | Unacceptable | Unacceptable |
| | | 0.1 | Good | Good | Good |
| | | 0.3 | Good | Good | Good |
| | | 0.5 | Good | Good | Good |
| | | 0.7 | Unacceptable | Unacceptable | Unacceptable |
| | 12 | 0.05 | Unacceptable | Unacceptable | Unacceptable |
| | | 0.1 | Acceptable | Acceptable | Acceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |

TABLE 6

| Immersion Solution | | | | | |
|---|---|---|---|---|---|
| Composition (wt %) | | | Target Food of the Test | | |
| | | Calcium | Chinese | | |
| Salt | Trehalose | lactate | radish | Apple | Sea bream |
| 7.0 | 0 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 1 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 2 | 0.05 | Unacceptable | Unacceptable | Unacceptable |
| | | 0.1 | Acceptable | Unacceptable | Unacceptable |
| | | 0.3 | Acceptable | Unacceptable | Unacceptable |
| | | 0.5 | Unacceptable | Unacceptable | Unacceptable |
| | | 0.7 | Unacceptable | Unacceptable | Unacceptable |
| | 6 | 0.05 | Unacceptable | Unacceptable | Unacceptable |
| | | 0.1 | Acceptable | Unacceptable | Unacceptable |
| | | 0.3 | Acceptable | Unacceptable | Unacceptable |
| | | 0.5 | Unacceptable | Unacceptable | Unacceptable |
| | | 0.7 | Unacceptable | Unacceptable | Unacceptable |
| | 10 | 0.05 | Unacceptable | Unacceptable | Unacceptable |
| | | 0.1 | Acceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |
| | 12 | 0.05 | Unacceptable | Unacceptable | Unacceptable |
| | | 0.1 | Unacceptable | Unacceptable | Unacceptable |
| | | 0.3 | Unacceptable | Unacceptable | Unacceptable |
| | | 0.5 | Unacceptable | Unacceptable | Unacceptable |
| | | 0.7 | Unacceptable | Unacceptable | Unacceptable |

### Example 2

Next, The relationship between the freezing treatment conditions and the quality of a frozen food was examined.

A Japanese butterbur (diameter: 10 mm, length: 8 cm), a cut pineapple (diameter: 120 mm, thickness: 20 mm) and a sea cucumber (length: 15 cm, weight: 160 g) were used as target foods for the test. They were immersed in an immersion solution containing 1.5 wt % of salt, 5 wt % of trehalose, 0.3 wt % of calcium chloride at 50° C. for 15 hours. After that, the immersed food materials were put into a bag, and the bag was deaerated and sealed. After that, freezing treatment was carried out using a high-voltage electric-field alcohol freezing machine.

Regarding section 1, the freezing time in the range of 0 to −5° C. was controlled to be 20 minutes, and freezing was continued to reach −25° C.

Regarding section 2, the freezing time in the range of 0 to −5° C. was controlled to be 15 minutes, and freezing was continued to reach −25° C.

Regarding section 3, the freezing time in the range of 0 to −5° C. was controlled to be 10 minutes, and freezing was continued to reach −25° C.

Regarding section 4, the freezing time in the range of 0 to −5° C. was controlled to be 10 minutes, and freezing was continued to reach −15° C.

Regarding section 5, the freezing time in the range of 0 to −5° C. was controlled to be 10 minutes, and freezing was continued to reach −20° C.

Regarding section 6, the freezing time in the range of 0 to −5° C. was controlled to be 10 minutes, and freezing was continued to reach −30° C.

Next, each frozen food material of each section was defrosted in running water, and after that, it was compared with a non-frozen food material (a control). The evaluation was made by a panel consisting of 10 persons as follows:
0: No difference from the control
−1: Inferior to the control
   +1: Excellent compared to the control
The results were derived from the average points of the evaluation.

The results are shown in Table 7.

When the freezing time in the range of 0 to −5° C. was 15 minutes or less, and the freezing temperature reached was −20° C. or less, there was no difference between the frozen food material and the control in the evaluation.

TABLE 7

| Duration (0 | Temperature | Japanese | | Sea |
|---|---|---|---|---|
| to −5° C.) | Reached | butterbur | Pineapple | Cucumber |
| 20 minutes | −25° C. | −0.5 | −0.3 | −0.6 |
| 15 minutes | −25° C. | −0.1 | 0.0 | −0.1 |
| 10 minutes | −25° C. | 0.0 | 0.0 | 0.0 |
| 10 minutes | −15° C. | −0.4 | −0.3 | −0.5 |
| 10 minutes | −20° C. | −0.1 | 0.0 | 0.0 |
| 10 minutes | −30° C. | 0.0 | 0.1 | 0.1 |

### Example 3

100 fresh laid eggs of fowls (size M) were subjected to heat treatment in hot water at 90° C. for 16 minutes. They were cooled in running water, and subsequently, they were peeled and immersed in an immersion solution containing 1 wt % of salt, 0.1 wt % of calcium lactate, 3 wt % of trehalose, and 5 wt % of reduced starch syrup at 5° C. for 15 hours.

After drained off, the eggs were divided into groups of 5 eggs and each group was put into a bag together with soup (oden dashi-jiru). After the bag was sealed, it was subjected to the heat treatment at 90° C. for 20 minutes. After cooling, the temperature range of 0 to −5° C. was passed through for 13 minutes and freezing was continued to reach −25° C. using liquid nitrogen.

After one month had passed, the eggs were defrosted and subjected to the taste test. Each egg had the same texture compared to the non-frozen boiled egg.

### Example 4

100 kg of raw soybean sprouts were immersed in an immersion solution containing 2 wt % of salt, 0.1 wt % of calcium citrate, 3 wt % of trehalose, and 3 wt % of sorbitol at 5° C. for 10 hours. After drained off, each 1 kg of the soybean sprout was put into a plastic bag, and the bag was deaerated and sealed.

The temperature range of 0 to −5° C. was passed through for 12 minutes and freezing was continued to reach −25° C. using a high-voltage electric-field alcohol freezing machine. After two months had passed, the soybean sprout was defrosted and sauteed. The sauteed soybean sprout had the same texture compared to the non-frozen sauteed soybean sprout.

What is claimed is:

1. A method for producing a frozen food comprising the steps of:
immersing at least one food material selected from the group consisting of vegetables, fruits, seafoods and eggs, in an aqueous solution containing salt, saccharide and calcium salts; and
freezing the food material immersed in the aqueous solution by being passed through a temperature range of 0 to −5°C. within 15 minutes to reach a temperature range of −20° C. or less.

2. A method for producing a frozen food according to claim 1, wherein the aqueous solution contains 1 to 5 wt % of salt, 2 to 10 wt % of saccharide and 0.1 to 0.5 wt % of calcium salts.

3. A method for producing a frozen food according to claim 1, wherein the step of freezing comprises the step of freezing the food material immersed in the aqueous solution by being passed through a temperature range of 0 to −5° C. within 12 minutes to reach a temperature range of −25° C. or less.

4. A method for producing a frozen food according to claim 1, wherein the aqueous solution contains 2 to 4 wt % of salt, 3 to 8 wt % of saccharide and 0.1 to 0.3 wt % of calcium salts.

5. A method for producing a frozen food according to claim 1, wherein the saccharide is at least one selected from the group consisting of trehalose, sugar, oligosaccharide, sugar alcohol, starch syrup and reduced starch syrup.

6. A method for producing a frozen food according to claim 1, wherein the calcium salts are at least one selected from the group consisting of calcium citrate, calcium lactate, calcium gluconate, calcium chloride, calcium carbonate and calcium phosphate.
